(19) United States
(12) Patent Application Publication
(10) Pub. No.: US 2010/0079892 A1
(43) Pub. Date: Apr. 1, 2010

(54) METHOD FOR PRODUCING MAGNETIC TRANSFER MASTER CARRIER, MAGNETIC TRANSFER MASTER CARRIER AND MAGNETIC TRANSFER METHOD

(75) Inventors: HIDEYUKI KUBOTA, KANAGAWA (JP); MAKOTO NAGAO, KANAGAWA (JP); RYUJI SUGITA, IBARAKI (JP); TAKASHI KOMINE, IBARAKI (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/569,131

(22) Filed: Sep. 29, 2009

(30) Foreign Application Priority Data
Sep. 30, 2008 (JP) 2008-254509

(51) Int. Cl. G11B 5/02; G11B 5/127

(52) U.S. Cl. 360/55; 216/22; G9B/5.026

(57) ABSTRACT

To provide a method for producing a magnetic transfer master carrier, including: plating a patterned silicon substrate with nickel so as to form a base material on the silicon substrate; separating the base material from the silicon substrate; and etching a surface of the base material so as to obtain an oriented base material, wherein the magnetic transfer master carrier includes the oriented base material, a thin underlying layer formed on the oriented base material, and a magnetic layer formed on the thin underlying layer.

### BACKGROUND OF THE INVENTION

1. Field of the Invention

The present invention relates to a method for producing a magnetic transfer master carrier used to magnetically transfer information to a perpendicular magnetic recording medium, a magnetic transfer master carrier, and a magnetic transfer method using the magnetic transfer master carrier.

2. Description of the Related Art

As magnetic recording media capable of recording information in a highly dense manner, perpendicular magnetic recording media are well known. An information recording area of a perpendicular magnetic recording medium is composed of narrow tracks. Thus, a tracking servo technique for accurate scanning with a magnetic head within a narrow track width and for reproducing a signal with a high S/N ratio is important for the perpendicular magnetic recording medium. To perform this tracking servo, it is necessary to record servo information, for example a servo signal for tracking, an address information signal, a reproduction clock signal, etc. as a so-called preformat at predetermined intervals on the perpendicular magnetic recording medium.

As a method for preformatting servo information on a perpendicular magnetic recording medium, there is, for example, a method wherein while a master carrier with a pattern including a magnetic layer, which corresponds to the servo information, is closely attached to the magnetic recording medium, a recording magnetic field (transfer magnetic field) is applied to the magnetic recording medium and the master carrier so as to magnetically transfer the pattern of the master carrier to the magnetic recording medium (refer to Japanese Patent Application Laid-Open (JP-A) Nos. 2003-203325 and 2000-195048 and U.S. Pat. No. 7,218,465B1, for example).

In this method, when the transfer magnetic field is applied to the magnetic recording medium and the master carrier with these closely attached to each other, a magnetic flux is absorbed into the magnetic layer on the pattern based upon the magnetized state of the master carrier, and the magnetic field is strengthened correspondingly to the concavo-convex shape of the pattern. By this magnetic field strengthened in the form of the pattern, only predetermined places on the magnetic recording medium are magnetized. Accordingly, magnetic materials with high saturation magnetization have hitherto been frequently used as materials for master magnetic layers (magnetic layers of master carriers).

Results of examinations conducted by the present inventors reveal that in the case where a magnetic material with high saturation magnetization is used as a material for a master magnetic layer, the high saturation magnetization is not effectively utilized because of a demagnetizing field with great strength generated when a transfer magnetic field is applied at the time of magnetic transfer. In an attempt to solve this problem, effectiveness of magnetic materials having perpendicular magnetic anisotropy has been disclosed. However, in order for a magnetic layer formed on a base material of a conventional master carrier to have satisfactory perpendicular magnetic anisotropy, it is necessary to provide a thick underlying layer between the base material and the magnetic layer. Unfortunately, when an attempt is made to obtain sufficient orientational properties by making the underlying layer thick, there is such a problem that the shape of the magnetic layer formed on the base material degrades, a transfer magnetic field is poorly distributed and the quality of a recording signal degrades.

### BRIEF SUMMARY OF THE INVENTION

The present invention is aimed at solving the problems in related art and achieving the following object. An object of the present invention is to provide a method for producing a magnetic transfer master carrier, which is capable of obtaining a highly-oriented magnetic layer whose shape hardly degrades even when an underlying layer is thin, and which is superior in signal quality; a magnetic transfer master carrier; and a magnetic transfer method using the magnetic transfer master carrier.

Means for solving the problems are as follows.

<1> A method for producing a magnetic transfer master carrier, including: plating a patterned silicon substrate with nickel so as to form a base material on the silicon substrate; separating the base material from the silicon substrate; and etching a surface of the base material so as to obtain an oriented base material, wherein the magnetic transfer master carrier includes the oriented base material, a thin underlying layer formed on the oriented base material, and a magnetic layer formed on the thin underlying layer.
<2> The method according to <1>, further including forming on the silicon substrate a c-axis oriented layer which contains a c-axis oriented material before the plating, wherein the base material including the c-axis oriented layer is separated from the silicon substrate in the separating, and the c-axis oriented layer is removed in the etching.
<3> The method according to <2>, wherein the c-axis oriented material is one of titanium and ruthenium.
<4> A magnetic transfer master carrier obtained by the method according to any one of <1> to <3>.
<5> The magnetic transfer master carrier according to <4>, wherein the thin underlying layer has a thickness of 1 nm to 15 nm.
<6> A magnetic transfer method including: initially magnetizing a perpendicular magnetic recording medium in a perpendicular direction; closely attaching the magnetic transfer master carrier according to one of <4> and <5> to the initially magnetized perpendicular magnetic recording medium; and transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other.

According to the present invention, it is possible to solve the problems in related art and achieve the object of providing a method for producing a magnetic transfer master carrier, which is capable of obtaining a highly-oriented magnetic layer whose shape hardly degrades even when an underlying layer is thin, and which is superior in signal quality; a magnetic transfer master carrier; and a magnetic transfer method using the magnetic transfer master carrier.

### BRIEF DESCRIPTION OF THE DRAWINGS

FIG. 1A is a drawing for explaining a method for producing a master disk, according to an embodiment.

FIG. 1B is a drawing for explaining the method for producing a master disk, according to the embodiment.

FIG. 1C is a drawing for explaining the method for producing a master disk, according to the embodiment.

FIG. 1D is a drawing for explaining the method for producing a master disk, according to the embodiment.

FIG. 1E is a drawing for explaining the method for producing a master disk, according to the embodiment.

FIG. 2A is a drawing for explaining the method for producing a master disk, according to the embodiment.

FIG. 2B is a drawing for explaining the method for producing a master disk, according to the embodiment.

FIG. 2C is a drawing for explaining the method for producing a master disk, according to the embodiment.

FIG. 3A is a drawing for explaining the method for producing a master disk, according to the embodiment.

FIG. 3B is a drawing for explaining the method for producing a master disk, according to the embodiment.

FIG. 3C is a drawing for explaining the method for producing a master disk, according to the embodiment.

FIG. 3D is a drawing for explaining the method for producing a master disk, according to the embodiment.

FIG. 4 is a top view of a master disk.

FIG. 5A is a partially cross-sectional view showing a master disk according to an embodiment.

FIG. 5B is a partially cross-sectional view showing a master disk according to another embodiment.

FIG. 6A is a drawing for explaining a step in a perpendicular magnetic recording transfer method.

FIG. 6B is a drawing for explaining a step in the perpendicular magnetic recording transfer method.

FIG. 6C is a drawing for explaining a step in the perpendicular magnetic recording transfer method.

FIG. 7 is a drawing for explaining a cross section of a slave disk.

FIG. 8 is a drawing for explaining the magnetization direction of a magnetic layer (recording layer) after an initially magnetizing step.

FIG. 9 is a drawing for explaining a magnetic transfer step.

FIG. 10 is a schematic structural drawing of a magnetic transfer apparatus used in the magnetic transfer step.

FIG. 11 is a drawing for explaining the magnetization direction of the magnetic layer (recording layer) after the magnetic transfer step.

FIG. 12 is a schematic drawing for explaining the total overhang of a thin underlying layer and a magnetic layer when formed over a master substrate (base material).

### DETAILED DESCRIPTION OF THE INVENTION

The following explains in detail a method for producing a magnetic transfer master carrier, a magnetic transfer master carrier, and a magnetic transfer method using the magnetic transfer master carrier.

### (Method for Producing Magnetic Transfer Master Carrier)

A method of the present invention for producing a magnetic transfer master carrier includes at least a plating step, a separating step and an etching step, and if necessary includes other step(s) such as a step of forming a c-axis oriented layer.

### <Plating Step>

The plating step is a step of plating a patterned silicon substrate with nickel so as to form a base material on the silicon substrate.

The way in which the plating step is carried out is not particularly limited and may be suitably selected according to the purpose. For example, electroplating or the like may be employed.

### <Separating Step>

The separating step is a step of separating the base material from the silicon substrate.

The way in which the separating step is carried out is not particularly limited and may be suitably selected according to the purpose. For example, physical separation using a dedicated jig, or the like may be employed.

### <Etching Step>

The etching step is a step of etching a surface of the base material so as to obtain an oriented base material of the magnetic transfer master carrier.

The etching step makes it possible to remove irregularly oriented surface portions from the base material and obtain the oriented base material having a highly-oriented surface.

The way in which the etching step is carried out is not particularly limited and may be suitably selected according to the purpose. For example, physical etching with Ar plasma, reactive etching, ion beam etching or the like may be employed.

### <Other Step(s)>

The other step(s) is/are not particularly limited and may be suitably selected according to the purpose. Examples thereof include a step of forming a c-axis oriented layer and a step of forming a protective film.

### <<Step of Forming C-Axis Oriented Layer>>

The step of forming a c-axis oriented layer is a step of forming on the silicon substrate a c-axis oriented layer which contains a c-axis oriented material before the plating step.

As to the c-axis oriented layer which contains the c-axis oriented material, the c-axis grows perpendicularly to the layer surface in a preferential manner, and when the c-axis oriented layer is plated with nickel so as to form a base material on the c-axis oriented layer, it is possible to enhance the orientational properties of portions of the base material adjacent to the c-axis oriented layer, which means that crystalline growth of the (111) plane, parallel to the layer surface, is possible.

Then, by removing the c-axis oriented layer in the etching step, it is possible to obtain an oriented base material having a highly-oriented surface.

### <<<C-axis Oriented Material and C-Axis Oriented Layer>>>

The c-axis oriented material is not particularly limited as long as it easily enables c-axis orientation, and may be suitably selected according to the purpose. Examples thereof include Ti and Ru.

The c-axis oriented layer is not particularly limited as long as it contains the c-axis oriented material, and may be suitably selected according to the purpose.

The amount of the c-axis oriented material contained in the c-axis oriented layer is not particularly limited and may be suitably selected according to the purpose.

The thickness of the c-axis oriented layer is not particularly limited and may be suitably selected according to the purpose. For example, the thickness is preferably 2 nm to 100 nm, more preferably 3 nm to 50 nm and even more preferably 5 nm to 30 nm.

### <Example of Method for Producing Magnetic Transfer Master Carrier>

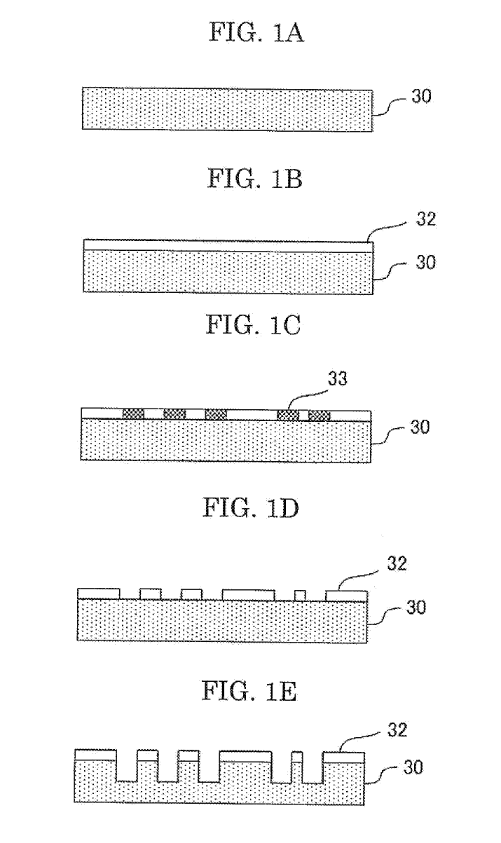

FIGS. 1A to 1E, FIGS. 2A to 2C and FIGS. 3A to 3D are drawings for explaining respective steps in producing a magnetic transfer master carrier (hereinafter also referred to as “master disk” or “master carrier”). An example of a method for producing a master disk according to an embodiment will be explained with reference to FIGS. 1A to 1E, FIGS. 2A to 2C and FIGS. 3A to 3D.

As shown in FIG. 1A, an original plate 30, which is a silicon wafer whose surface is smooth, is prepared, an electron beam resist solution is applied onto this original plate 30 by spin coating or the like so as to form a resist layer 32 thereon (see FIG. 1B), and the resist layer 32 is baked (pre-baked).

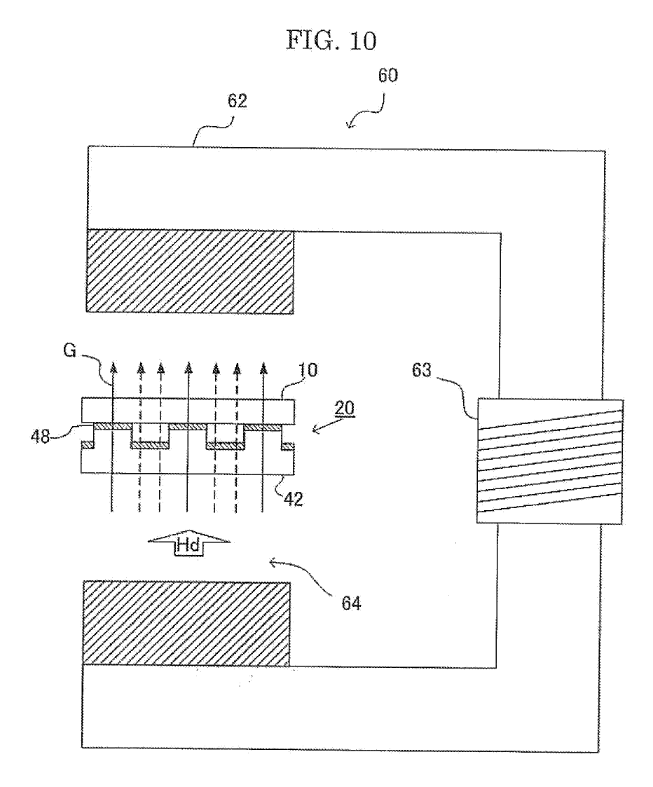

Next, the original plate 30 is set on a high-precision rotary stage or X-Y stage provided in an electron beam exposure apparatus (not shown), an electron beam modulated correspondingly to a servo signal is applied while the original plate 30 is being rotated, and a predetermined pattern 33 is formed on the substantially entire surface of the resist layer 32; for example, a pattern that corresponds to a servo signal and that linearly extends in radius directions from the rotational center toward each track is formed at portions corresponding to frames on the circumference by writing exposure (electron beam writing) (see FIG. 10.

Subsequently, as shown in FIG. 1D, the resist layer 32 is developed, the exposed (written) portions are removed, and a coating layer having a desired thickness is formed by the remaining resist layer 32. This coating layer serves as a mask in a subsequent step (etching step). Additionally, the resist applied onto the original plate 30 can be of positive type or negative type; it should be noted that an exposed (written) pattern formed when a positive-type resist is used is an inversion of an exposed (written) pattern formed when a negative-type resist is used. After this developing process, a baking process (post-baking) is carried out to enhance the adhesion between the resist layer 32 and the original plate 30.

Subsequently, as shown in FIG. 1E, parts of the original plate 30 are removed (etched) at places where opening portions of the resist layer 32 exist, such that hollows having a predetermined depth are formed in the original plate 30. As to this etching, anisotropic etching is desirable in that an undercut (side etching) can be minimized. Reactive ion etching (RIE) can be suitably employed as such anisotropic etching.

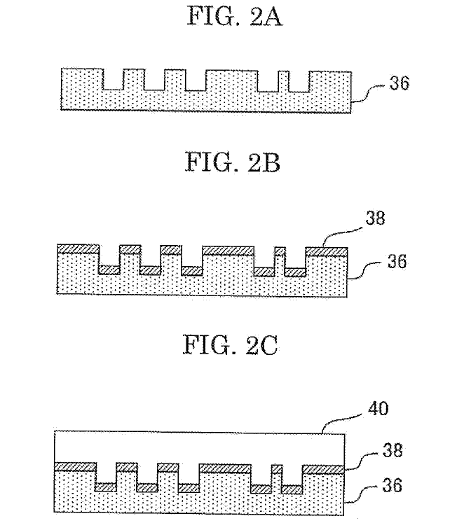

Thereafter, as shown in FIG. 2A, the resist layer 32 is removed. Regarding the method for removing the resist layer 32, ashing can be employed as a dry method, and a removal method using a release liquid can be employed as a wet method. By the ashing process, an original master (silicon substrate) 36 on which an inversion of a desired concavo-convex pattern is formed is produced.

Subsequently, as shown in FIG. 2B, a conductive layer 38 is formed on the surface of the original master 36 so as to have a uniform thickness. The method for forming this conductive layer 38 can be suitably selected from metal deposition methods and the like, including PVD (physical vapor deposition) and CVD (chemical vapor deposition). Formation of one layer made of a conductive film (denoted by the numeral 38), as described above, makes it possible to obtain such an effect that a metal can be uniformly electrodeposited in a subsequent step (electroforming step). The conductive layer 38 is preferably a film composed mainly of Ni. Since such a film composed mainly of Ni can be easily formed and is hard, it is suitable as the conductive film. The thickness of the conductive layer 38 is not particularly limited; generally though, the thickness is several tens of nanometers or so.

Note that the above-mentioned c-axis oriented layer may be formed instead of the conductive layer 38. Alternatively, both the conductive layer 38 and the above-mentioned c-axis oriented layer may be formed. The method for forming the c-axis oriented layer is not particularly limited. For example, a method similar to the method for forming the conductive layer 38 may be employed.

Then, as shown in FIG. 2C, a metal plate 40 made of a metal (Ni in this case), which has a desired thickness, is laid over the surface of the original master 36 by electroforming (plating step). This plating step is performed by immersing the original master 36 in an electrolytic solution placed in an electroforming device, utilizing the original master 36 as an anode, and passing an electric current between the anode and a cathode. The concentration of the electrolytic solution, the pH, the manner in which the electric current is applied, etc. are required to be adjusted under an optimized condition where the laid metal plate 40 does not warp.

The original master 36 over which the metal plate 40 has been laid as described above is taken out from the electrolytic solution in the electroforming device and then immersed in purified water placed in a release bath (not shown).

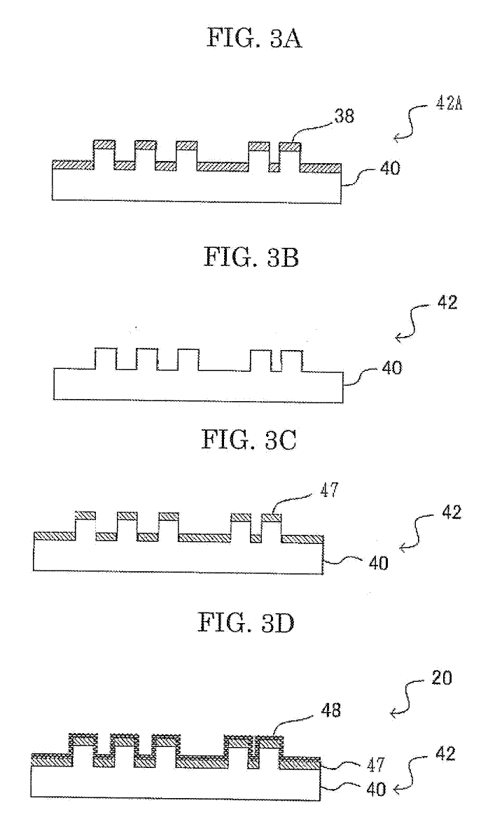

Subsequently, in the release bath, the metal plate 40 is separated from the original master 36 (separating step), and a crude master substrate 42A (base material) having a concavo-convex pattern which is an inversion of the concavo-convex pattern of the original master 36 is thus obtained as shown in FIG. 3A.

Subsequently, the surface of the crude master substrate 42A is etched so as to remove the conductive layer 38, and a master substrate 42 (oriented base material) is obtained as shown in FIG. 3B (etching step).

Next, as shown in FIG. 3C, a thin underlying layer 47 is formed on the concavo-convex surface of the master substrate 42. The material for the thin underlying layer 47 is, for example, a metal, alloy or compound which contains at least one selected from the group consisting of Pt, Ru, Pd, Co, Cr, Ni, W, Ta, Al, P, Si and Ti. The thickness of the thin underlying layer 47 is preferably in the range of 1 nm to 30 nm, more preferably in the range of 1 nm to 20 nm, and even more preferably in the range of 1 nm to 15 nm. The thin underlying layer 47 is, for example, formed by sputtering using a target made of the above-mentioned material.

Subsequently, as shown in FIG. 3D, a magnetic layer 48 is formed on the thin underlying layer 47. Examples of the material for the magnetic layer 48 include CoPt. The thickness of the magnetic layer 48 is preferably 10 nm to 320 nm, more preferably 20 nm to 300 nm, and even more preferably 30 nm to 100 nm. The magnetic layer 48 is formed by sputtering, using a target made of the above-mentioned material.

Thereafter, the master substrate 42 is subjected to punching such that its inner and outer diameters have predetermined sizes. By the above-mentioned process, a master disk 20 having the concavo-convex pattern provided with the magnetic layer 48 is produced as shown in FIG. 3D.

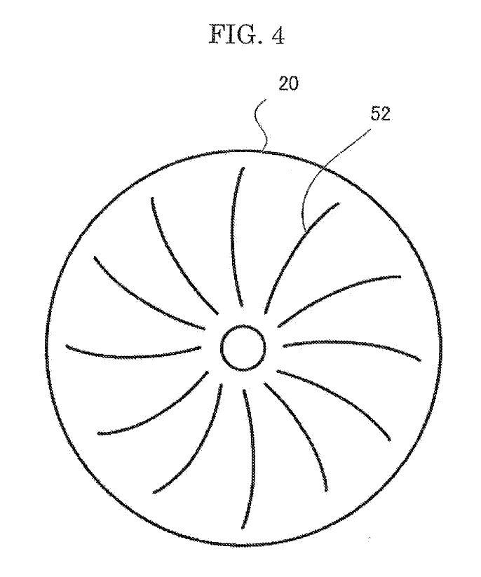

FIG. 4 is a top view of the master disk 20. As shown in FIG. 4, a servo pattern 52 that is a concavo-convex pattern is formed on the surface of the master disk 20. Also, although not shown therein, a protective film (protective layer) made, for example, of diamond-like carbon may be provided over the magnetic layer 48 (see FIG. 3D) on the surface of the master disk 20, and further, a lubricant layer may be provided over the protective film.

The purpose of the provision of the protective layer is to prevent a case in which when the master disk 20 is closely attached to the after-mentioned slave disk, the magnetic layer 48 easily gets scratched and the use of the master disk 20 is thus made impossible. The lubricant layer has an effect of preventing, for example, formation of scratches attributed to friction caused when the master disk 20 is brought into contact with the slave disk, and thusly improving the durability of the master disk 20.

Specifically, a preferred structure is as follows: a carbon film having a thickness of 2 nm to 30 nm is formed as a protective layer, and a lubricant layer is formed thereon. Also, in order to enhance the adhesion between the magnetic layer 48 and the protective layer, an adhesion enhancing layer of Si or the like may be formed on the magnetic layer 48 before forming the protective layer.

### (Magnetic Transfer Master Carrier)

A magnetic transfer master carrier of the present invention is obtained by the above-mentioned method for producing a magnetic transfer master carrier. The magnetic transfer master carrier of the present invention includes at least an oriented base material, a thin underlying layer formed on the oriented base material, and a magnetic layer formed on the thin underlying layer, and if necessary includes other layer(s).

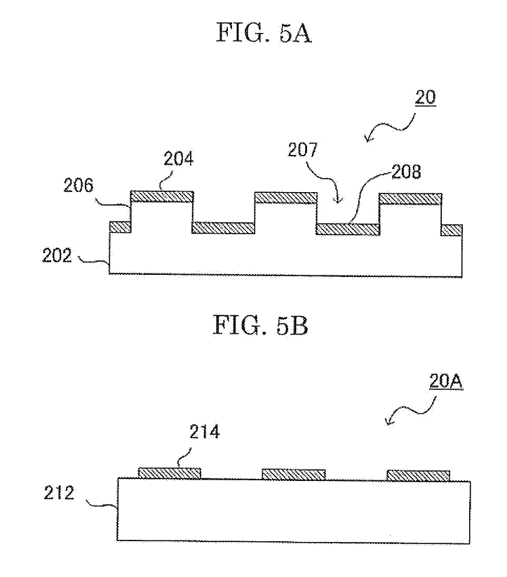

FIG. 5A is a partially cross-sectional view of the master disk (master carrier) 20 serving as an example of a magnetic transfer master carrier of the present invention. This master disk 20 includes an oriented base material 202 and a magnetic layer 204 formed on the surface of the oriented base material 202. The oriented base material 202 is provided with convex portions 206 and concave portions 207 on its surface. The convex portions 206 are provided with the magnetic layer 204 on their surfaces. Additionally, in the present embodiment, a magnetic layer 208 is formed on the surfaces of the concave portions 207 for the sake of facilitation of production, etc. In other embodiments, however, the provision of the magnetic layer 208 in the concave portions 207 may be omitted.

The magnetic layer 204 formed at the surfaces (apical surfaces) of the convex portions 206 of the oriented base material 202 serves as bit portions corresponding to transfer signal(s). These bit portions are portions to reverse an initial magnetization, and are equivalent to transfer portions. Meanwhile, the concave portions 207 are equivalent to non-transfer portions where a magnetization is not reversed.

FIG. 5B is a partially cross-sectional view showing a master disk 20A according to another embodiment. This master disk 20A includes an oriented base material 212 and, on the surface of the oriented base material 212, a magnetic layer 214 serving as bit portions corresponding to transfer signal(s). As to this master disk 20A, the magnetic layer 214 is equivalent to transfer portions, and portions (gaps) between adjacent sections of the magnetic layer 214 are equivalent to non-transfer portions.

### <Oriented Base Material>

The oriented base material is produced using a known material, for example glass, a synthetic resin such as polycarbonate, a metal such as nickel or aluminum, silicon or carbon.

### <Magnetic Layer>

The magnetic layer has perpendicular magnetic anisotropy, and the magnetic anisotropy energy (Ku) of the magnetic layer is preferably 3×10⁶ erg/cm³ or greater. This magnetic anisotropy energy (Ku) can be measured using a known magnetic anisotropy torquemeter.

In the case where the magnetic anisotropy energy of the magnetic layer is 3×10⁶ erg/cm³ or greater, it is possible to reduce the decrease in magnetization amount caused by effects of a demagnetizing field generated in the magnetic layer when a transfer magnetic field (Hd) is applied in a perpendicular direction. Meanwhile, in the case where the magnetic anisotropy energy is less than 3×10⁶ erg/cm³, effects of a demagnetizing field generated in the magnetic layer are so great when a transfer magnetic field (Hd) is applied, that the magnetic layer decreases in magnetization amount and magnetic transfer properties cannot be sufficiently secured.

The saturation magnetization (Ms) of the magnetic layer is preferably 500 emu/cc or above. When the saturation magnetization is less than 500 emu/cc, it is possible that even when the magnetic layer has perpendicular magnetic anisotropy and is magnetized in a saturated manner, a sufficient difference in transfer magnetic field strength between convex portions and concave portions may not be secured and thus adequate transfer properties may not be secured.

Also, the nucleation magnetic field (Hn) of the magnetic layer is preferably a positive value (Hn>0). When the nucleation magnetic field (Hn) is 0 or less (Hn≦0), a magnetic field with great strength is generated from the magnetic layer even after removal of a transfer magnetic field subsequent to the finish of magnetic transfer, so that overwriting may arise, making it impossible to record a desired signal.

The nucleation magnetic field (Hn) of the magnetic layer is preferably lower than or equal to the applied magnetic field (transfer magnetic field, Hd) in strength because the saturation magnetization (Ms) of the magnetic layer can be effectively utilized.

The saturation magnetization (emu/cc) and the nucleation magnetic field (Hn) of the magnetic layer can be calculated using a known vibrating sample magnetometer. The saturation magnetization (emu/cc) can be calculated by measuring the saturation magnetic moment (emu) from a magnetization curve obtained using the vibrating sample magnetometer, and dividing the saturation magnetic moment by the volume (cc) of the magnetic layer. The nucleation magnetic field (Hn) can be calculated from the magnetization curve.

The value of the remanent magnetization (Mr) of the magnetic layer is preferably small. When it is greater than a certain value, a magnetic field is generated from the master disk even after the transfer magnetic field has stopped being applied, so that when the master disk is separated from a slave disk, unnecessary transfer may occur, which leads to signal noise. The remanent magnetization (Mr) of the magnetic layer is preferably equivalent to 80% or less of the value of the saturation magnetization; specifically, it is preferably 400 emu/cc or less.

When the value of the coercive force (Hc) of the magnetic layer is too large, the magnetic layer is not magnetized by the applied magnetic field, so that magnetic transfer is difficult. When a transfer magnetic field with great strength is applied, the magnetic field in the concave portions is strengthened. Therefore, the coercive force (Hc) of the magnetic layer is preferably weaker than or equal to the coercive force of a corresponding perpendicular magnetic recording medium; specifically, it is preferably 6,000 Oe or less, more preferably 4,000 Oe or less.

The material used for the magnetic layer of the master disk (master carrier) is an alloy or compound composed of at least one ferromagnetic metal selected from Fe, Co and Ni and at least one nonmagnetic substance selected from Cr, Pt, Ru, Pd, Si, Ti, B, Ta and O. It is particularly desirable that the material be an alloy (CoPt) composed of Co and Pt.

Magnetic transfer is performed a plurality of times, using the master disk over which the hard protective layer and the lubricant layer have been formed.

Parenthetically, since minute pinholes exist in the hard protective layer and the coverage of the lubricant layer is often low, it is possible that moisture may enter from the pinholes in the step of performing magnetic transfer a plurality of times, and thus an oxide of a component of the magnetic layer may form over the surface of the master disk in the case where the master disk is a conventional master disk. Owing to the formation of the oxide, the volume of the magnetic layer increases, expanded portions of the magnetic layer have convex shapes and there is a physical defect in the surface of a slave disk in some cases.

Especially when a conventional master disk having a magnetic layer made of FeCo is brought into contact with a slave disk, there is such a problem that oxidation and corrosion of a metal element of the magnetic layer, particularly Fe, selectively arise.

In contrast, use of a master disk having a magnetic layer made of CoPt composed of Co and Pt, which are lower in ionization tendency than Fe, makes it possible to greatly reduce the adverse effects of the problem.

The magnetic layer of the master disk (master carrier) can be formed by sputtering, for example. In the case where the magnetic layer is formed of CoPt, its composition can be controlled primarily by adjusting the Pt concentration. When the sputter pressure is set at a low level when the magnetic layer is formed, it is possible to increase the magnetic anisotropy energy (Ku). It should, however, be noted that when the sputter pressure is set at lower than 0.1 Pa, electric discharge is generally difficult. The sputter pressure is preferably 0.1 Pa to 50 Pa, and more preferably 0.1 Pa to 10 Pa. The Pt concentration is preferably 5 at. % to 30 at. %, and more preferably 10 at. % to 25 at. %.

### <Thin Underlying Layer>

In order to adjust the perpendicular orientation, magnetic anisotropy energy (Ku) and nucleation magnetic field (Hn) of the magnetic layer of the master disk (master carrier), the thin underlying layer is formed under the magnetic layer (between the magnetic layer and the oriented base material).

The material for the thin underlying layer is, for example, a metal, alloy or compound that contains at least one selected from the group consisting of Pt, Ru, Pd, Co, Cr, Ni, W, Ta, Al, P, Si and Ti. The material for the thin underlying layer is preferably a platinum group metal such as Pt or Ru, or an alloy thereof. The thin underlying layer may have a single-layer structure or a multilayer structure.

The thickness of the thin underlying layer is preferably in the range of 1 nm to 30 nm, more preferably in the range of 1 nm to 20 nm, and even more preferably in the range of 1 nm to 15 nm. When the thickness of the thin underlying layer is greater than 30 nm, the shape of the magnetic layer formed on the pattern of the master disk may degrade, thereby possibly leading to poor distribution of a transfer magnetic field and degradation of the quality of a recording signal. When the thickness of the thin underlying layer is less than 1 nm, perpendicular orientation of the magnetic layer may be impossible, or the magnetic anisotropy energy and nucleation magnetic field of the magnetic layer may not be able to be controlled.

The thickness of the thin underlying layer is preferably 20 nm or less. When the thickness is 20 nm or less, it is possible to reduce degradation of the shape of the pattern after the formation of the magnetic layer and greatly improve magnetic transfer properties.

Conventionally, in order to perpendicularly orient a magnetic layer, it is necessary to adjust the thickness of an underlying layer to 30 nm or greater.

Meanwhile, in the present invention, since the base material has a highly-oriented surface, it is possible to perpendicularly orient the magnetic layer even when the underlying layer is thin. This makes it possible to reduce the total thickness of the underlying layer and the magnetic layer formed over the base material. Consequently, the shape of the magnetic layer hardly degrades, and superior transfer signal quality can be obtained.

### <Other Layer(s)>

The above-mentioned other layer(s) is/are not particularly limited and may be suitably selected according to the purpose. Examples thereof include a protective layer.

### <<Protective Layer>>

The protective layer is formed over the surface of the master disk to improve the mechanical properties, friction resistance and weatherability of the master disk. As the material for this protective layer, a hard carbon film is preferable, and inorganic carbon, diamond-like carbon, etc. formed by sputtering may be used. Further, a layer formed of a lubricant (a lubricant layer) may be formed over this hard protective layer.

A fluorine resin, e.g. perfluoropolyether (PFPE), is generally used as such a lubricant.

### (Magnetic Transfer Method)

A magnetic transfer method of the present invention includes at least an initially magnetizing step, a closely attaching step and a magnetic transfer step and, if necessary, includes other step(s).

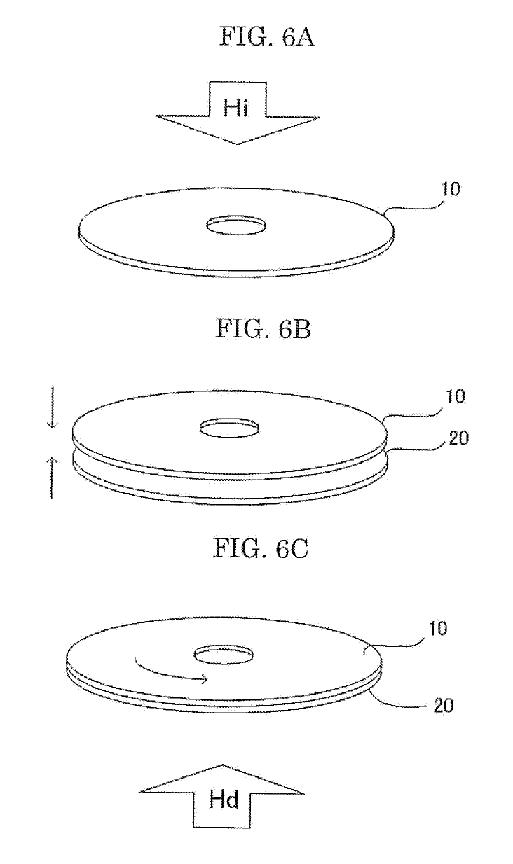

An outline of a magnetic transfer technique for perpendicular magnetic recording will be explained with reference to FIGS. 6A to 6C. FIGS. 6A to 6C are drawings for explaining respective steps in a magnetic transfer method for perpendicular magnetic recording. In FIGS. 6A to 6C, the numeral 10 denotes a slave disk (which is equivalent to a perpendicular magnetic recording medium) as a magnetic disk to which information is to be transferred, and the numeral 20 denotes a master disk as a magnetic transfer master carrier.

As shown in FIG. 6A, a DC magnetic field (Hi) is applied to a surface of the slave disk 10 from a perpendicular direction so as to initially magnetize the slave disk 10 (initially magnetizing step).

After the initially magnetizing step, the initially magnetized slave disk 10 and the master disk 20 are closely attached to each other as shown in FIG. 6B (closely attaching step).

After these disks 10 and 20 have been closely attached to each other, a magnetic field (Hd), which acts in the opposite direction to the direction of the magnetic field (Hi) applied at the time of the initial magnetization, is applied to the disks as shown in FIG. 6C, such that the information which the master disk 20 has is magnetically transferred to the slave disk 10 (magnetic transfer step).

### [Explanation of Slave Disk (Perpendicular Magnetic Recording Medium)]

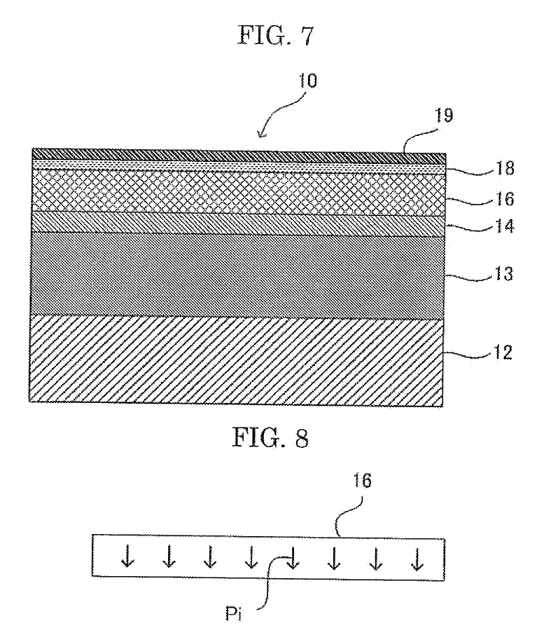

The slave disk 10 shown in FIG. 7 includes a disc-shaped substrate, and slave magnetic layer(s) formed over one or both surfaces of the substrate. Specific examples thereof include high-density hard disks. The following explains a perpendicular magnetic recording medium with reference to FIG. 7, employing the slave disk 10 as an example.

FIG. 7 is a drawing for explaining a cross section of the slave disk 10. As shown in FIG. 7, the slave disk 10 includes a nonmagnetic substrate 12 made, for example, of glass and also includes a soft magnetic layer (soft magnetic underlying layer: SUL) 13, a nonmagnetic layer (intermediate layer) 14 and a slave magnetic layer (perpendicular magnetic recording layer) 16 formed over the substrate 12. Further, a protective layer 18 and a lubricant layer 19 are formed over the slave magnetic layer 16. Note that although an example in which the slave magnetic layer 16 is formed over one surface of the substrate 12 is herein shown, an aspect in which slave magnetic layers are formed over both surfaces of the substrate 12 is possible as well.

The disc-shaped substrate 12 is made of a nonmagnetic material such as glass or Al (aluminum). After the soft magnetic layer 13 is formed on the substrate 12, the nonmagnetic layer 14 and the slave magnetic layer 16 are formed.

The soft magnetic layer 13 is useful in that the perpendicularly magnetized state of the slave magnetic layer 16 can be stabilized and sensitivity at the times of recording and reproduction can be improved. The material used for the soft magnetic layer 13 is preferably selected from soft magnetic materials, for example CoZrNb, FeTaC, FeZrN, FeSi alloys, FeAl alloys, FeNi alloys such as permalloy, and FeCo alloys such as permendur. This soft magnetic layer 13 is provided with magnetic anisotropy from the center of the disk toward the outside, with magnetization easy axes being oriented in radius directions.

The thickness of the soft magnetic layer 13 is preferably 20 nm to 2,000 nm, and more preferably 40 nm to 400 nm.

The nonmagnetic layer 14 is provided in order to increase the magnetic anisotropy of the subsequently formed slave magnetic layer 16 in a perpendicular direction or for some other reason. The material used for the nonmagnetic layer 14 is preferably selected from Ti (titanium), Cr (chromium), CrTi, CoCr, CrTa, CrMo, NiAl, Ru (ruthenium), Pd (palladium), Ta, Pt and the like. The nonmagnetic layer 14 is formed by depositing the material by means of sputtering. The thickness of the nonmagnetic layer 14 is preferably 10 nm to 150 nm, and more preferably 20 nm to 80 nm.

The slave magnetic layer 16 is formed of a perpendicular magnetization film (which is configured such that magnetization easy axes in a slave magnetic layer are oriented primarily perpendicularly to the substrate), and information is to be recorded in this slave magnetic layer 16. The material used for the slave magnetic layer 16 is preferably selected from Co (cobalt), Co alloys (CoPt, CoPtCr, CoCr, CoPtCrTa, CoPtCrNbTa, CoCrB, CoNi, etc.), Co alloy-SiO₂, Co alloy-TiO₂, Fe alloys (FePt, FeCoNi, etc.) and the like. High in magnetic flux density, any of these materials can have perpendicular magnetic anisotropy by adjustment of a deposition condition and/or its composition. The slave magnetic layer 16 is formed by depositing the material by means of sputtering. The thickness of the slave magnetic layer 16 is preferably 10 nm to 500 nm, more preferably 20 nm to 200 nm.

In the present embodiment, a disc-shaped glass substrate having an outer diameter of 65 mm is used as the substrate 12 of the slave disk 10, the glass substrate is set in a chamber of a sputtering apparatus, and the pressure is reduced to 1.33×10⁻⁵ Pa (1.0×10⁻⁷ Torr); thereafter, Ar (argon) gas is introduced into the chamber, and a first SUL having a thickness of 80 nm is deposited by sputtering with the use of a CoZrNb target provided in the chamber, the temperature of the substrate also in the chamber being set at room temperature. Subsequently, a Ru layer having a thickness of 0.8 nm is deposited on the first SUL by sputtering with the use of a Ru target provided in the chamber. Further, a second SUL having a thickness of 80 nm is deposited on the Ru layer by sputtering with the use of a CoZrNb target. When the first SUL and the second SUL are formed, magnetic anisotropy with magnetization easy axes being oriented in radius directions is provided by applying a magnetic field having a strength of 50 Oe or greater in the radius directions.

Next, sputtering deposition is carried out by means of electric discharge under such a condition that the substrate temperature is made equal to room temperature, with the use of a Ru target. In this manner, the nonmagnetic layer 14 formed of Ru is deposited so as to have a thickness of 20 nm.

Thereafter, in a similar manner, Ar gas is introduced, and sputtering deposition is carried out by means of electric discharge under such a condition that the substrate temperature is made equal to room temperature, with the use of a CoCrPt—SiO₂ target provided in the same chamber. In this manner, the slave magnetic layer 16 which is formed of CoCrPt—SiO₂ and has a granular structure is deposited so as to have a thickness of 20 nm.

By the above-mentioned process, the transfer magnetic disk (slave disk) 10, in which the soft magnetic layer, the nonmagnetic layer and the slave magnetic layer have been deposited over the glass substrate, is produced.

### <Initially Magnetizing Step>

As shown in FIG. 6A, initial magnetization (DC magnetization) of the slave disk 10 is performed by generation of an initializing magnetic field Hi with the use of a device (magnetic field applying unit (not shown)) capable of applying a DC magnetic field perpendicularly to the surface of the slave disk 10. Specifically, it is performed by generating as the initializing magnetic field Hi a magnetic field which is greater than or equal to the coercive force Hc of the slave disk 10 in strength. By this initially magnetizing step, the slave magnetic layer 16 of the slave disk 10 is subjected to an initial magnetization Pi in one direction perpendicular to the disk surface, as shown in FIG. 8. It should be noted that this initially magnetizing step may be carried out by rotating the slave disk 10 relatively to the magnetic field applying unit.

### <Closely Attaching Step>

Next, a step (closely attaching step) is carried out in which, as shown in FIG. 6B, the master disk 20 and the initially magnetized slave disk 10 are laid one on top of the other and closely attached to each other. In the closely attaching step, as shown in FIG. 6B, the surface of the master disk 20 on the side of the protrusion pattern (concavo-convex pattern) and the surface of the slave disk 10 on the side of the slave magnetic layer 16 are closely attached to each other with a predetermined pressing force.

Before closely attached to the master disk 20, the slave disk 10 is, if necessary, subjected to a cleaning process (burnishing or the like) in which minute protrusions or attached dust on its surface is removed using a glide head, a polisher, etc.

As to the closely attaching step, there is a case in which the master disk 20 is closely attached to only one surface of the slave disk 10 as shown in FIG. 6B, and there is another case in which master disks are closely attached to both surfaces of a transfer magnetic disk, where slave magnetic layers have been formed. The latter case is advantageous in that transfer to both the surfaces can be simultaneously performed.

### <Magnetic Transfer Step>

Next, the magnetic transfer step is explained with reference to FIG. 6C. To the slave disk 10 and the master disk 20 that have been closely attached to each other by the closely attaching step, a recording magnetic field Hd is generated in the opposite direction to the direction of the initializing magnetic field Hi by a magnetic field applying unit (not shown). Magnetic transfer is effected by entry of a magnetic flux, produced by generating the recording magnetic field Hd, into the slave disk 10 and the master disk 20.

In the present embodiment, the value of the recording magnetic field Hd is approximately equal to that of the coercive force Hc of the magnetic material constituting the slave magnetic layer 16 of the slave disk 10.

In the magnetic transfer, while the slave disk 10 and the master disk 20 closely attached to each other are being rotated by a rotating unit (not shown), the recording magnetic field Hd is applied by the magnetic field applying unit, and information in the form of the protrusion pattern, recorded on the master disk 20, is magnetically transferred to the slave magnetic layer 16 of the slave disk 10. Apart from this structure, a mechanism for rotating the magnetic field applying unit may be provided such that the magnetic field applying unit is rotated relatively to the slave disk 10 and the master disk 20.

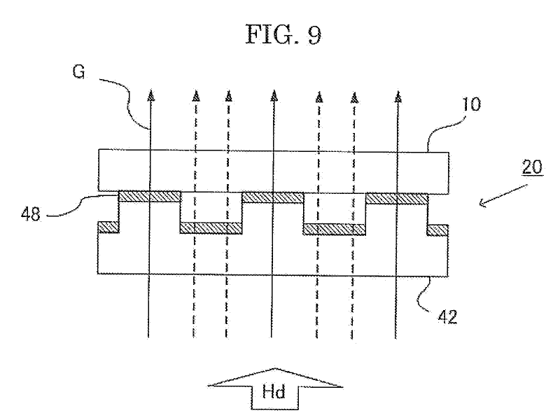

FIG. 9 shows a cross section of the slave disk 10 and the master disk 20 in the magnetic transfer step. When the recording magnetic field Hd is applied with the slave disk 10 closely attached to the master disk 20 having the concavo-convex pattern as shown in FIG. 9, a magnetic flux G becomes strong in areas where the convex portions of the master disk 20 and the slave disk 10 are in contact with each other, the recording magnetic field Hd causes the magnetization direction of the magnetic layer 48 of the master disk 20 to align with the direction of the recording magnetic field Hd, and thus the magnetic information is transferred to the slave magnetic layer 16 of the slave disk 10. Meanwhile, at the concave portions of the master disk 20, the magnetic flux G generated by the application of the recording magnetic field Hd is weaker than at the convex portions, and the magnetization direction of portions of the slave magnetic layer 16 of the slave disk 10 which correspond to the concave portions does not change, so that the portions remain in the initially magnetized state.

FIG. 10 shows in a detailed manner a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to the master disk 20 and the slave magnetic layer 16 of the slave disk 10 in a closely attached state. The direction of the magnetic field generated can be changed depending upon the direction of the electric current applied to the coil 63. Therefore, both initial magnetization of the slave disk 10 and magnetic transfer can be performed by this magnetic transfer apparatus.

In the case where magnetic transfer is carried out after initial magnetization is performed, using this magnetic transfer apparatus, an electric current which flows in the opposite direction to the direction of an electric current applied to the coil 63 of the magnetic field applying unit 60 at the time of the initial magnetization is applied to the coil 63. This makes it possible to generate a recording magnetic field in the opposite direction to the magnetization direction at the time of the initial magnetization. In the magnetic transfer, while the slave disk 10 and the master disk 20 closely attached to each other are being rotated, the recording magnetic field Hd is applied by the magnetic field applying unit 60, and the information in the form of the protrusion pattern, recorded on the master disk 20, is magnetically transferred to the slave magnetic layer 16 of the slave disk 10; accordingly, a rotating unit (not shown) is provided. Apart from this structure, a mechanism for rotating the magnetic field applying unit 60 may be provided such that the magnetic field applying unit 60 is rotated relatively to the slave disk 10 and the master disk 20.

In the present embodiment, magnetic transfer is effected by applying as the recording magnetic field Hd a magnetic field which is equivalent in strength to 40% to 130%, preferably 50% to 120%, of the coercive force Hc of the slave magnetic layer 16 of the slave disk 10 used in the present embodiment.

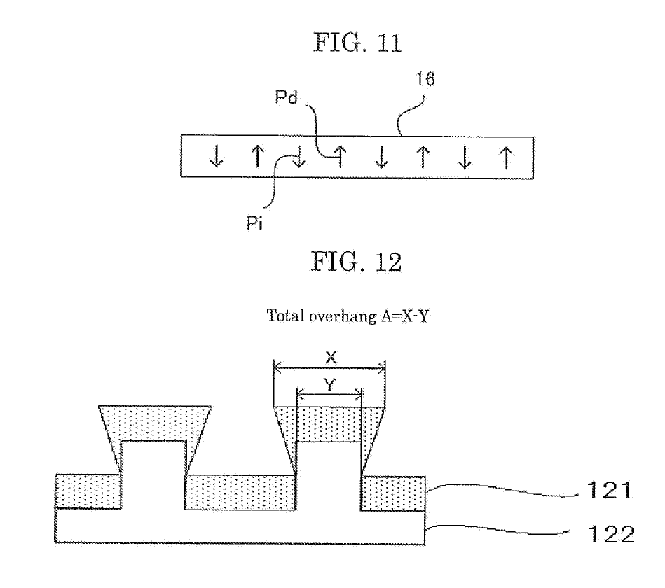

Thus, in the slave magnetic layer 16 of the slave disk 10, information in the form of a magnetic pattern, such as a servo signal, is recorded as a recording magnetization Pd which acts in the opposite direction to the direction of the initial magnetization Pi (see FIG. 11).

In carrying out the present invention, the protrusion pattern formed on the master disk 20 may be a negative pattern, as opposed to the positive pattern explained with FIG. 3B. In this case, a similar magnetization pattern can be magnetically transferred to the slave magnetic layer 16 of the slave disk 10 by reversing the direction of the initializing magnetic field Hi and the direction of the recording magnetic field Hd. Also, although a case where the magnetic field applying unit is an electromagnet has been explained in the present embodiment, a permanent magnet which similarly generates a magnetic field may be used as well.

A perpendicular magnetic recording medium produced by the method according to the above-mentioned embodiment of the present invention will be used, installed in a magnetic recording and reproducing device such as a hard disk device, for example. This makes it possible to obtain a high-recording-density magnetic recording and reproducing device with high servo precision and excellent recording and reproducing properties.

### Examples

The following explains the present invention in more specific terms, referring to Examples and Comparative Examples. It should, however, be noted that the present invention is not confined to these Examples in any way.

### Comparative Example 1

### Production of Magnetic Transfer Master Carrier

First of all, plating with nickel was carried out in accordance with the following procedure (plating step).

A Ni film (conductive layer) was formed on the surface of an original master (patterned silicon substrate) so as to have a uniform thickness (9 nm). The method for forming the conductive layer may be selected, from a variety of metal deposition methods; in Comparative Example 1, sputtering was employed.

The formation of the conductive layer yields such an effect that metal can be uniformly electrodeposited at the time of electroforming.

The conductive layer is preferably a film composed mainly of nickel, and the thickness thereof is preferably in the range of several nanometers to several tens of nanometers or so although not particularly limited.

Subsequently, by electroforming, a metal plate formed of a metal (nickel in this case) having a desired thickness was laid over the surface of the original master covered with the Ni film. As to how this process was carried out, the original master was immersed in an electrolytic solution placed in an electroforming apparatus, and electricity was passed between an anode and a cathode, with the original master serving as the anode.

The metal plate and the conductive layer were separated from the original master (separating step), and a base material of a magnetic transfer master carrier was thus obtained.

Next, a thin underlying layer (Pt) and a magnetic layer (CoPt) were deposited over the obtained base material.

These layers were deposited by sputtering under the following conditions, using a general sputtering apparatus.

The conditions under which the thin underlying layer (Pt) was deposited were as follows: deposition pressure=0.12 Pa, distance between base material and target=75 mm, electric power=300 W DC, layer thickness=10 nm

The conditions under which the magnetic layer (CoPt) was deposited were as follows: deposition pressure=0.15 Pa, distance between base material and target=200 mm, electric power=1,000 W DC, layer thickness=20 nm

CoPt (Co: 80 at. %, Pt: 20 at. %) was used as the material for the magnetic layer.

The deposition pressure is preferably 0.1 Pa to 50 Pa, and more preferably 0.1 Pa to 10 Pa. The Pt concentration is preferably 5 at. % to 50 at. %, and more preferably 10 at. % to 25 at. %. The sputter gas used in forming the magnetic layer by the sputtering may be conventionally used Ar gas or other noble gas. Also, the power applied in forming the magnetic layer by the sputtering is preferably 0.6 W/cm² to 16.0 W/cm², and more preferably 3.0 W/cm² to 10.0 W/cm².

### <Evaluation of Orientation>

Evaluations of orientation were carried out utilizing X-ray diffraction.

X'Pert Pro (manufactured by PANalytical) was used as an X-ray diffraction apparatus, and the Bragg-Brentano method was employed.

As a means of making comparisons of orientation, the half width (ΔΘ50) of each peak was utilized. Here, it should be noted that since it is difficult to make comparisons of orientation by using absolute values, the comparisons were made by using relative values, with the value of a sample (of Comparative Example 1) obtained by a conventional production method serving as a reference value.

Specifically, the half widths (ΔΘ50) of peaks corresponding to the c-axis orientation of the CoPt magnetic layer (hereinafter referred to as “CoPt (002)” for short) and the Ni surface (111) orientation (hereinafter referred to as “Ni (111)” for short) of the base material surface after the separating step in Comparative Example 1 served as reference values, and evaluations of orientation were carried out using values relative to these reference values.

<Evaluation of Medium with Transferred Magnetic Signal>

The waveform of a preamble portion of a magnetic signal transferred to a medium was taken into an oscilloscope, and the S/N value was calculated. As to the S/N value, effects of variation were greatly reduced by calculating the average value concerning 190 frames (bit length=100 nm).

Also, relative comparisons of the S/N value were made using the unit “dB”, with the S/N value of a medium, to which a magnetic signal had been transferred using the magnetic transfer master carrier of Comparative Example 1, serving as a reference value.

<Evaluation of Shape of Thin Underlying Layer and Magnetic Layer Formed over Base Material of Master Carrier>

The shape of the thin underlying layer and the magnetic layer was examined by producing an ultrathin section thereof with the use of an FIB and then observing the section with a TEM (transmission electron microscope). This is a method for observing a cross section of a thin film formed on a master carrier, whereby differences of even nanometer order can be confirmed. In accordance with this method, the total overhang A of the thin underlying layer and the magnetic layer (see FIG. 12) when formed was calculated. In FIG. 12, the numeral 121 denotes the thin underlying layer and the magnetic layer (the thin underlying layer and the magnetic layer are drawn as one layer in FIG. 12 for the sake of simplicity), and the numeral 122 denotes a master substrate (base material).

Here, the total overhang A means the value obtained by subtracting Y from X, where X denotes the maximum width of the magnetic layer with respect to the direction perpendicular to the thickness direction of the magnetic layer on a convex portion, and Y denotes the maximum width of the convex portion with respect to the direction perpendicular to the thickness direction of the magnetic layer on the convex portion.

### Example 1

A magnetic transfer master carrier was produced in the same manner as in Comparative Example 1, except that after the separating step was carried out, the following etching step was carried out, and subsequently the thin underlying layer and the magnetic layer were formed.

### <Etching Step>

For the etching step, physical etching with Ar plasma was employed. The conditions under which the etching step was carried out were as follows.

Etching conditions: pressure=0.3 Pa, distance between base material and target=75 mm, electric power=100 W DC, time=120 sec

Under these conditions, the outermost surface of the base material (Ni) obtained by the separating step was etched such that the etching depth was equivalent to the sum of the thickness of the conductive layer (9 nm) formed and 10 nm.

The etching depth is preferably the sum of the thickness of the conductive layer formed and 10 nm to 30 nm.

In the cases where the etching step was carried out, Ni (111) was evaluated after the etching step.

### Example 2

A magnetic transfer master carrier was produced in the same manner as in Example 1, except that, in the etching step, the outermost surface of the base material (Ni) was etched such that the etching depth was equivalent to the sum of the thickness of the conductive layer (9 nm) formed and 20 nm.

### Example 3

A magnetic transfer master carrier was produced in the same manner as in Example 1, except that, in the etching step, the outermost surface of the base material (Ni) was etched such that the etching depth was equivalent to the sum of the thickness of the conductive layer (9 nm) formed and 40 nm.

### Example 4

A magnetic transfer master carrier was produced in the same manner as in Example 2, except that the thickness of the thin underlying layer (Pt) was changed from 10 nm to 5 nm.

### Example 5

A magnetic transfer master carrier was produced in the same manner as in Example 3, except that the thickness of the thin underlying layer (Pt) was changed from 10 nm to 5 nm.

### Example 6

### Step of Forming C-Axis Oriented Layer

A Ti film was deposited on the original master before the plating step of Comparative Example 1. For the deposition, a general sputtering apparatus was used, and the conditions under which the Ti film was deposited were as follows.

Deposition conditions: deposition pressure=0.5 Pa, distance between substrate and target=75 mm, electric power=500 W DC, film thickness=10 nm

In Example 6, plating with nickel was carried out after the Ti film had been deposited so as to have a thickness of 10 nm; judging from other experimental results, the thickness of the Ti film is preferably in the range of 3 nm to 10 nm.

### <Plating Step>

A plating step was carried out in the same manner as in Comparative Example 1, except that the Ni film (conductive layer) was not formed.

### <Separating Step>

A separating step was carried out in the same manner as in Comparative Example 1.

### <Etching Step>

After the separating step, the Ti film as a c-axis oriented layer was removed by etching, and further etching was carried out in a depth of 20 nm.

In the cases where the step of forming a c-axis oriented layer was carried out, Ni (111) was evaluated after the etching.

### <Formation of Thin Underlying Layer (Pt) and Magnetic Layer (CoPt)>

A magnetic transfer master carrier was produced by forming a thin underlying layer (Pt) and a magnetic layer (CoPt) in the same manner as in Comparative Example 1, except that the thickness of the thin underlying layer (Pt) was changed from 10 nm to 5 nm.

### Example 7

A magnetic transfer master carrier was produced in the same manner as in Example 6, except that the thickness of the thin underlying layer (Pt) was changed from 5 nm to 3 nm.

### Example 8

A magnetic transfer master carrier was produced in the same manner as in Example 6, except that the thickness of the thin underlying layer (Pt) was changed from 5 nm to 1 nm.

### Example 9

A magnetic transfer master carrier was produced in the same manner as in Example 6, except that the thickness of the thin underlying layer (Pt) was changed from 5 nm to 10 nm.

### Example 10

A magnetic transfer master carrier was produced in the same manner as in Example 6, except that the thickness of the thin underlying layer (Pt) was changed from 5 nm to 20 nm.

### Comparative Example 2

A magnetic transfer master carrier was produced in the same manner as in Comparative Example 1, except that the thin underlying layer (Pt) was not provided.

### Comparative Example 3

A magnetic transfer master carrier was produced in the same manner as in Comparative Example 1, except that the thickness of the thin underlying layer (Pt) was changed from 10 nm to 20 nm.

### Comparative Example 4

A magnetic transfer master carrier was produced in the same manner as in Comparative Example 1, except that the thickness of the thin underlying layer (Pt) was changed from 10 nm to 30 nm.

### Example 11

A magnetic transfer master carrier was produced in the same manner as in Example 6, except that a Ru film was used instead of the Ti film.

### Example 12

A magnetic transfer master carrier was produced in the same manner as in Example 7, except that a Ru film was used instead of the Ti film.

### Example 13

A magnetic transfer master carrier was produced in the same manner as in Example 8, except that a Ru film was used instead of the Ti film.

### Example 14

A magnetic transfer master carrier was produced in the same manner as in Example 9, except that a Ru film was used instead of the Ti film.

### Example 15

A magnetic transfer master carrier was produced in the same manner as in Example 10, except that a Ru film was used instead of the Ti film.

TABLE 1

| | (1) | | | | | | Magnetic |
|---|---|---|---|---|---|---|---|
| | Deposition | | Pt | | X-ray diffraction | | transfer |
| | of Ni, Ti or | (2) | underlying | Total | (ΔΘ50 of each peak) | | signal |
| | Ru | Ar etching | layer | overhang | 1. Ni(1 1 1) | 2. CoPt(0 0 2) | (S/N: dB) |
| Comp. | 9 nm (Ni) | — | 10 nm | 6 nm | 1.0 | 1.0 | — |
| Ex. 1 | | | | | | | |
| Ex. 1 | 9 nm (Ni) | 10 nm | 10 nm | 6 nm | 0.91 to 1.06 | 0.98 to 1.07 | +0.2 |
| Ex. 2 | 9 nm (Ni) | 20 nm | 10 nm | 6 nm | 0.60 to 0.78 | 0.64 to 0.82 | +0.3 |
| Ex. 3 | 9 nm (Ni) | 40 nm | 10 nm | 6 nm | 0.62 to 0.74 | 0.59 to 0.75 | +0.3 |
| Ex. 4 | 9 nm (Ni) | 20 nm | 5 nm | 5 nm | 0.60 to 0.78 | 0.72 to 0.86 | +0.8 |
| Ex. 5 | 9 nm (Ni) | 40 nm | 5 nm | 5 nm | 0.62 to 0.74 | 0.76 to 0.79 | +0.8 |
| Ex. 6 | 10 nm (Ti) | 20 nm | 5 nm | 5 nm | 0.33 to 0.37 | 0.31 to 0.39 | +1.4 |
| Ex. 7 | 10 nm (Ti) | 20 nm | 3 nm | 4.6 nm | 0.33 to 0.37 | 0.51 to 0.57 | +1.6 |
| Ex. 8 | 10 nm (Ti) | 20 nm | 1 nm | 4.2 nm | 0.35 to 0.38 | 0.33 to 0.39 | +1.5 |
| Ex. 9 | 10 nm (Ti) | 20 nm | 10 nm | 6 nm | 0.43 to 0.57 | 0.42 to 0.49 | +0.5 |
| Ex. 10 | 10 nm (Ti) | 20 nm | 20 nm | 8 nm | 0.52 to 0.62 | 0.58 to 0.65 | +0.4 |
| Comp. | 9 nm (Ni) | — | Not | 4 nm | 1.45 | 1.63 | −1.8 |
| Ex. 2 | | | provided | | | | |
| Comp. | 9 nm (Ni) | — | 20 nm | 8 nm | 1.14 to 1.20 | 1.22 to 1.42 | −0.7 |
| Ex. 3 | | | | | | | |
| Comp. | 9 nm (Ni) | — | 30 nm | 10 nm | 1.21 to 1.35 | 1.38 to 1.53 | −1.0 |
| Ex. 4 | | | | | | | |
| Ex. 11 | 10 nm (Ru) | 20 nm | 5 nm | 5 nm | 0.34 to 0.40 | 0.34 to 0.39 | +1.2 |
| Ex. 12 | 10 nm (Ru) | 20 nm | 3 nm | 4.6 nm | 0.31 to 0.36 | 0.30 to 0.37 | +1.5 |
| Ex. 13 | 10 nm (Ru) | 20 nm | 1 nm | 4.2 nm | 0.32 to 0.36 | 0.33 to 0.37 | +1.4 |
| Ex. 14 | 10 nm (Ru) | 20 nm | 10 nm | 6 nm | 0.44 to 0.56 | 0.40 to 0.51 | +0.4 |
| Ex. 15 | 10 nm (Ru) | 20 nm | 20 nm | 8 nm | 0.54 to 0.63 | 0.59 to 0.66 | +0.4 |

The results shown in Table 1 demonstrate that in the cases where the CoPt film was formed on the Ni base material in accordance with the procedures of Examples 1 to 15, the formation of the thin underlying layer alone could enhance the c-axis orientational properties of the CoPt film.

The comparisons between Comparative Example 1 and Examples 1 to 3 demonstrate that in the cases where the thin underlying layers formed had the same thickness, higher c-axis orientational properties could be obtained by the method of the present invention than by the conventional method. Also, it was found that when the thin underlying layer had a reduced thickness as in Examples 4 to 8 and 11 to 13, high c-axis orientational properties could be obtained as well.

When the thin underlying layer was thicker as in Comparative Examples 1, 3 and 4, the total thickness of the thin underlying layer and the magnetic layer formed over the base material of the magnetic transfer master carrier increased, so that there were effects of degradation of the shape of the magnetic layer, which could lead to degradation of the quality of a magnetic transfer signal.

Meanwhile, when no thin underlying layer was provided as in Comparative Example 2, the c-axis orientational properties were low, which could lead to degradation of the quality of a magnetic transfer signal.

By using this method, it is possible to greatly reduce degradation of the shape of a magnetic layer formed on a magnetic transfer master carrier and thus to obtain superior transfer signal quality.

What is claimed is:

1. A method for producing a magnetic transfer master carrier, comprising:
plating a patterned silicon substrate with nickel so as to form a base material on the silicon substrate,
separating the base material from the silicon substrate, and
etching a surface of the base material so as to obtain an oriented base material,
wherein the magnetic transfer master carrier comprises the oriented base material, a thin underlying layer formed on the oriented base material, and a magnetic layer formed on the thin underlying layer.

2. The method according to claim 1, further comprising forming on the silicon substrate a c-axis oriented layer which contains a c-axis oriented material before the plating, wherein the base material including the c-axis oriented layer is separated from the silicon substrate in the separating, and the c-axis oriented layer is removed in the etching.

3. The method according to claim 2, wherein the c-axis oriented material is one of titanium and ruthenium.

4. A magnetic transfer master carrier comprising:
an oriented base material,
a thin underlying layer formed on the oriented base material, and
a magnetic layer formed on the thin underlying layer,
wherein the magnetic transfer master carrier is obtained by a method for producing a magnetic transfer master carrier, which comprises plating a patterned silicon substrate with nickel so as to form a base material on the silicon substrate, separating the base material from the silicon substrate, and etching a surface of base material so as to obtain the oriented base material.

5. The magnetic transfer master carrier according to claim 4, wherein the thin underlying layer has a thickness of 1 nm to 15 nm.

6. A magnetic transfer method comprising:
initially magnetizing a perpendicular magnetic recording medium in a perpendicular direction,
closely attaching a magnetic transfer master carrier to the initially magnetized perpendicular magnetic recording medium, and
transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other,
wherein the magnetic transfer master carrier comprises an oriented base material, a thin underlying layer formed on the oriented base material, and a magnetic layer formed on the thin underlying layer, and
wherein the magnetic transfer master carrier is obtained by a method for producing a magnetic transfer master carrier, which comprises plating a patterned silicon substrate with nickel so as to form a base material on the silicon substrate, separating the base material from the silicon substrate, and etching a surface of the base material so as to obtain the oriented base material.
